(19) United States
(12) Patent Application Publication
(10) Pub. No.: US 2008/0268306 A1
(43) Pub. Date: Oct. 30, 2008

(54) Hydrogen generating apparatus fuel cell power generation system

(75) Inventors: Chang-Ryul Jung, Seoul (KR); Jae-Hyuk Jang, Seongnam-si (KR); Hong-Ryul Lee, Suwon-si (KR); Jae-Hyoung Gil, Seoul (KR); Bo-Sung Ku, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 12/078,476

(22) Filed: Mar. 31, 2008

(30) Foreign Application Priority Data
Apr. 25, 2007 (KR) 10-2007-0040556

(51) Int. Cl. H01M 8/06; C25B 9/00

(52) U.S. Cl. 429/19; 204/242; 204/278

(57) ABSTRACT

A hydrogen generating apparatus and a fuel cell power generation system are disclosed. The hydrogen generating apparatus may include: an electrolyte bath, which contains an electrolyte solution; a first electrode, which is coupled to one side within the electrolyte bath, and which is configured to generate electrons; and a second electrode, which is coupled to the one side within the electrolyte bath with a predetermined distance from the first electrode, and which is configured to generate hydrogen using the electrons and the electrolyte solution. The apparatus can be structured to have electrodes and conductive coating layers secured to the inside of the electrolyte bath, to reduce resistance between the electrodes and an external circuit and facilitate the movement of electrons.

### CROSS-REFERENCE TO RELATED APPLICATIONS

This application claims the benefit of Korean Patent Application No. 10-2007-0040556 filed with the Korean Intellectual Property Office on Apr. 25, 2007, the disclosure of which is incorporated herein by reference in its entirety.

### BACKGROUND

1. Technical Field

The present invention relates to a hydrogen generating apparatus and a fuel cell power generation system.

2. Description of the Related Art

A fuel cell is an apparatus that converts the chemical energies of fuel (hydrogen, LNG, LPG, methanol, etc.) and air directly into electricity and heat, by means of electrochemical reactions. In contrast to conventional power generation techniques, which employ the processes of burning fuel, generating vapor, driving turbines, and driving power generators, the utilization of fuel cells does not entail combustion processes or driving apparatus. As such, the fuel cell is the result of new technology for generating power that offers high efficiency and few environmental problems.

FIG. 1 is a diagram illustrating the operating principle of a fuel cell.

Referring to FIG. 1, a fuel cell 100 may include a fuel electrode 110 as an anode and an air electrode 130 as a cathode. The fuel electrode 110 receives molecular hydrogen (H₂), which is dissociated into hydrogen ions (H⁺) and electrons (e⁻). The hydrogen ions move past a moisture absorption layer 120 towards the air electrode 130. This moisture absorption layer 120 corresponds to an electrolyte layer. The electrons move through an external circuit 140 to generate an electric current. The hydrogen ions and the electrons combine with the oxygen in the air at the air electrode 130 to generate water. The following Reaction Scheme 1 represents the chemical reactions described above.

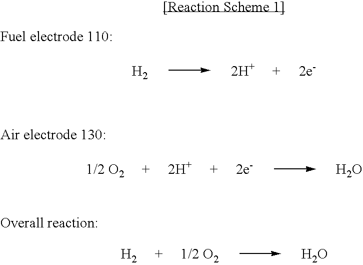

In short, the fuel cell can function as a battery, as the electrons dissociated from the fuel electrode 110 generate a current that passes through the external circuit. Such a fuel cell 100 is a relatively pollution-free power source, because it does not produce any polluting emissions such as SOx, NOx, etc., and produces only little amounts of carbon dioxide. The fuel cell may also offer several other advantages, such as low noise and little vibration, etc.

In order for the fuel cell 100 to generate electrons at the fuel electrode 110, a hydrogen generating apparatus may be needed, which modifies a regular fuel containing hydrogen atoms into a gas having a high hydrogen content, as required by the fuel cell 100.

A hydrogen storage tank can be used, as a commonly known substitute for the hydrogen generating apparatus, but the tank apparatus occupies a large volume and has to be kept with special care.

FIG. 2 is a cross-sectional view schematically illustrating a conventional hydrogen generating apparatus. As illustrated, an anode 220 made of magnesium and a cathode 230 made of stainless steel may be immersed in an aqueous electrolyte solution 215 inside an electrolyte bath 210.

The basic principle of the hydrogen generating apparatus 200 is that electrons are generated at the magnesium electrode 220, which has a greater tendency to ionize than the stainless steel electrode 230, and the generated electrons travel to the stainless steel 230 electrode. The electrons can then react with the aqueous electrolyte solution 215 to generate hydrogen.

Here, positioning the magnesium and stainless steel electrodes in alternation can increase the amount of hydrogen generated. However, in a hydrogen generating apparatus structured as such, an increase in the number of electrodes may lead to an increase in volume occupied by the electrodes, and thus may not be applicable in compact and low-thickness electronic devices.

In order for the fuel cell to suitably accommodate the demands in current portable electronic devices (e.g. cell phones, laptops, etc.) for high-capacity power supply apparatus, the fuel cell needs to have a small volume while providing high performance.

The fuel cell may employ a method of generating hydrogen after reforming fuel, such as methanol or formic acid, etc., approved by the ICAO (International Civil Aviation Organization) for boarding on airplanes, or may employ a method of using methanol, ethanol, or formic acid, etc., directly as the fuel.

However, the former case may require a high reforming temperature, a complicated system, and high driving power, and is likely to have impurities (e.g. CO₂, CO, etc.) included, besides pure hydrogen. On the other hand, the latter may entail the problem of very low power density, due to the low rate of a chemical reaction at the anode and the cross-over of hydrocarbons through the moisture absorption layer.

### SUMMARY

An aspect of the invention provides a hydrogen generating apparatus and a fuel cell power generation system, which can generate pure hydrogen at room temperature using electrochemical reactions, and which have simple structures capable of controlling the amount of hydrogen generated without requiring separate BOP (Balance of Plant) equipment. The hydrogen generating apparatus and a fuel cell power generation system may reduce resistance between the circuits and the electrodes.

Another aspect of the invention provides a hydrogen generating apparatus that includes: an electrolyte bath, which contains an electrolyte solution; a first electrode, which is coupled to one side within the electrolyte bath, and which is configured to generate electrons; and a second electrode, which is coupled to the one side within the electrolyte bath with a predetermined distance from the first electrode, and which is configured to generate hydrogen using the electrons and the electrolyte solution.

A first indentation can be formed on the one side within the electrolyte bath, and one end of the first electrode can be inserted and secured in the first indentation.

In certain embodiments, the hydrogen generating apparatus can further include a control unit configured to control an amount of electrons flowing from the first electrode to the second electrode.

A first conductive coating layer can further be included between the one end of the first electrode and an inner wall of the electrolyte bath formed by the first indentation, where the first conductive coating layer can be made from gold. The first conductive coating layer may be formed by at least one of an inkjet coating method, a spray coating method, a sputtering method, and a thin film deposition method.

The first electrode and the second electrode can be arranged in a vertical structure.

The hydrogen generating apparatus may further include a third electrode, which may be coupled to the one side within the electrolyte bath, and which may be configured to generate electrons; and a fourth electrode, which may be coupled to the one side within the electrolyte bath with a predetermined distance from the third electrode, and which may be configured to generate hydrogen using the electrons and the electrolyte solution.

Also, a fifth electrode may be included, which may be coupled to the other side within the electrolyte bath, and which may be configured to generate electrons, as well as a sixth electrode, which may be coupled to the other side within the electrolyte bath with a predetermined distance from the fifth electrode, and may be configured to generate hydrogen using the electrons and the electrolyte solution.

In the other side within the electrolyte bath, a second indentation may be formed in which one end of the fifth electrode may be inserted and secured.

The hydrogen generating apparatus may also include a control unit configured to control an amount of electrons flowing from the fifth electrode to the sixth electrode.

In certain embodiments, a second conductive coating layer may be included between the one end of the fifth electrode and an inner wall of the electrolyte bath formed by the second indentation, where the second conductive coating layer can be made from gold.

The fifth electrode and the sixth electrode can be arranged in a vertical structure, and the first electrode and the fifth electrode can be formed as an integrated body.

The electrolyte bath may further include a hydrogen outlet through which the hydrogen may be discharged.

Yet another aspect of the invention provides a fuel cell power generation system that includes: a hydrogen generating apparatus, which includes an electrolyte bath that contains an electrolyte solution, a first electrode that is coupled to one side within the electrolyte bath and configured to generate electrons, and a second electrode that is coupled to the one side within the electrolyte bath with a predetermined distance from the first electrode and configured to generate hydrogen using the electrons and the electrolyte solution; and a fuel cell, which is configured to receive the hydrogen generated by the hydrogen generating apparatus and convert the chemical energy of the hydrogen into electrical energy, to thereby produce a direct electrical current.

A first indentation can be formed on the one side within the electrolyte bath, and one end of the first electrode can be inserted and secured in the first indentation.

In certain embodiments, a control unit may further be included, which may be configured to control an amount of electrons flowing from the first electrode to the second electrode.

A first conductive coating layer can further be included between the one end of the first electrode and an inner wall of the electrolyte bath formed by the first indentation, where the first conductive coating layer can be made from gold. The first conductive coating layer may be formed by at least one of an inkjet coating method, a spray coating method, a sputtering method, and a thin film deposition method.

The first electrode and the second electrode can be arranged in a vertical structure.

The fuel cell power generation system may further include a third electrode, which may be coupled to the one side within the electrolyte bath, and which may be configured to generate electrons; and a fourth electrode, which may be coupled to the one side within the electrolyte bath with a predetermined distance from the third electrode, and which may be configured to generate hydrogen using the electrons and the electrolyte solution.

Also, a fifth electrode may be included, which may be coupled to the other side within the electrolyte bath, and which may be configured to generate electrons, as well as a sixth electrode, which may be coupled to the other side within the electrolyte bath with a predetermined distance from the fifth electrode, and may be configured to generate hydrogen using the electrons and the electrolyte solution.

In the other side within the electrolyte bath, a second indentation may be formed in which one end of the fifth electrode may be inserted and secured.

A control unit may also be included, which may be configured to control an amount of electrons flowing from the fifth electrode to the sixth electrode.

A second conductive coating layer may be included between the one end of the fifth electrode and an inner wall of the electrolyte bath formed by the second indentation, where the second conductive coating layer can be made from gold.

The fifth electrode and the sixth electrode can be arranged in a vertical structure, and the first electrode and the fifth electrode can be formed as an integrated body.

In certain embodiments, the electrolyte bath may further include a hydrogen outlet configured to discharge the hydrogen.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 is a diagram illustrating the operating principle of a fuel cell.

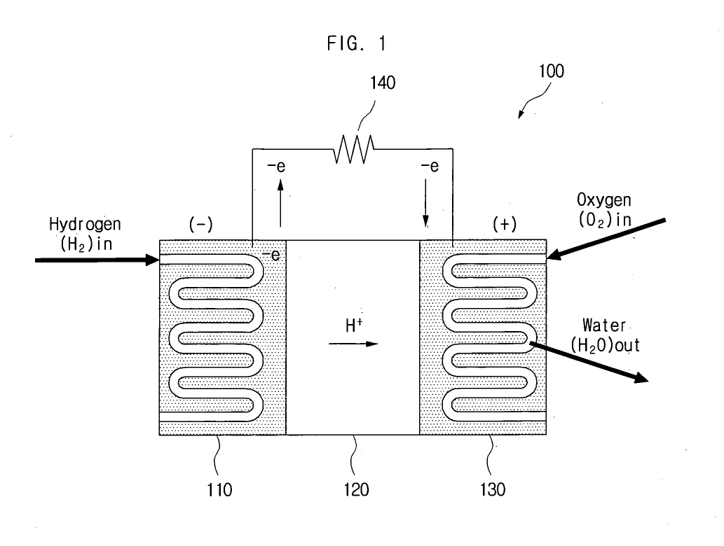

FIG. 2 is a cross-sectional view schematically illustrating a conventional hydrogen generating apparatus.

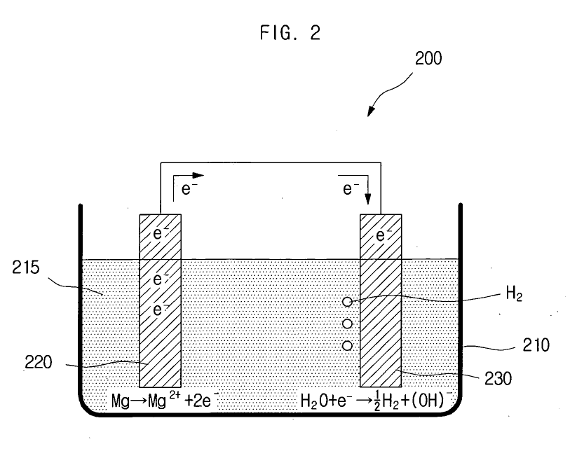

FIG. 3 is a cross-sectional view schematically illustrating a hydrogen generating apparatus according to an embodiment of the invention.

FIG. 4 is a cross-sectional view schematically illustrating a hydrogen generating apparatus according to another embodiment of the invention.

### DETAILED DESCRIPTION

As the invention allows for various changes and numerous embodiments, particular embodiments will be illustrated in drawings and described in detail in the written description. However, this is not intended to limit the present invention to particular modes of practice, and it is to be appreciated that all changes, equivalents, and substitutes that do not depart from the spirit and technical scope of the present invention are encompassed in the present invention. In the description of the present invention, certain detailed explanations of related art are omitted when it is deemed that they may unnecessarily obscure the essence of the invention.

While such terms as “first” and “second,” etc., may be used to describe various components, such components must not be limited to the above terms. The above terms are used only to distinguish one component from another. For example, a first component may be referred to as a second component without departing from the scope of rights of the present invention, and likewise a second component may be referred to as a first component. The term “and/or” encompasses both combinations of the plurality of related items disclosed and any one item from among the plurality of related items disclosed.

When a component is mentioned to be “connected to” or “accessing” another component, this may mean that it is directly formed on or stacked on the other component, but it is to be understood that another component may exist in-between. On the other hand, when a component is mentioned to be “directly connected to” or “directly accessing” another component, it is to be understood that there are no other components in-between.

The terms used in the present application are merely used to describe particular embodiments, and are not intended to limit the present invention. An expression used in the singular encompasses the expression of the plural, unless it has a clearly different meaning in the context. In the present application, it is to be understood that the terms such as “including” or “having,” etc., are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

Unless otherwise defined, all terms used herein, including technical or scientific terms, have the same meanings as those generally understood by those with ordinary knowledge in the field of art to which the present invention belongs. Such terms as those defined in a generally used dictionary are to be interpreted to have the meanings equal to the contextual meanings in the relevant field of art, and are not to be interpreted to have ideal or excessively formal meanings unless clearly defined in the present application.

Certain embodiments of the invention will now be described below in more detail with reference to the accompanying drawings.

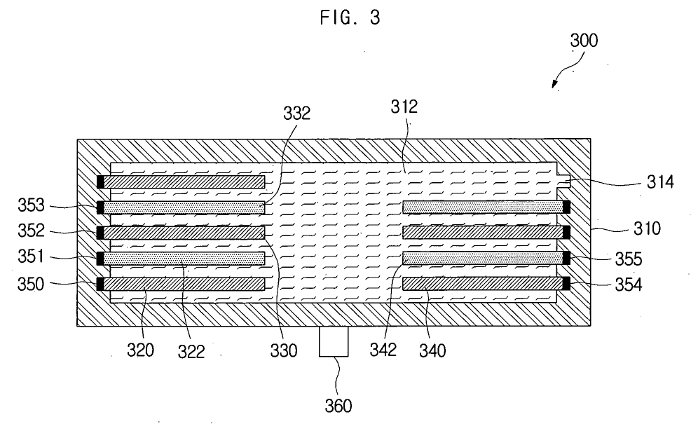

FIG. 3 is a cross-sectional view schematically illustrating a hydrogen generating apparatus according to an embodiment of the invention.

The hydrogen generating apparatus 300 may include an electrolyte bath 310, an electrolyte solution 312, first electrodes 320, 330, 340, second electrodes 322, 332, 342, an indentation 314, conductive coating layers 350, 351, 352, 353, 354, 355, and a hydrogen outlet 360. For better understanding and easier explanation, the following description will focus on an example configuration in which the first electrode 320 is made of magnesium (Mg) and the second electrode 322 is made of stainless steel.

The electrolyte bath 310 may contain an electrolyte solution 312 inside. The electrolyte solution 312 may contain hydrogen ions, which can be used by the hydrogen generating apparatus 300 to generate hydrogen gas.

A compound such as LiCl, KCl, NaCl, KNO₃, NaNO₃, CaCl₂, MgCl₂, K₂SO₄, Na₂SO₄, MgSO₄, AgCl, etc., can be used as the electrolyte in the electrolyte solution 312.

A first electrode 320 may be coupled to one side inside the electrolyte bath 310 and may generate electrons. Here, to refer to the first electrode 320 being coupled can encompass the concept of the first electrode 320 being secured to the electrolyte bath 310. While this particular embodiment describes the first electrode 320 being secured to the electrolyte bath 310 by way of an indentation 314, the invention is not thus limited, and it is apparent that various other methods of securing may be employed.

The first electrode 320 may be an active electrode, where the magnesium (Mg) is oxidized into a magnesium ion (Mg²⁺) releasing two electrons, due to the difference in ionization energy between magnesium and water (H₂O). The electrons thus generated may travel through a wire to the control unit (not shown), and then through a wire to a second electrode 322. As such, the first electrode 320 may be expended in accordance with the electrons generated, and may have to be replaced after a certain period of time. Also, the first electrode 320 may be made of a metal having a greater tendency to ionize than the material used for the second electrode 322.

As described above, an indentation may be formed in one side within the electrolyte bath 310, by which to couple the first electrode 320 to the electrolyte bath 310, so that one end of the first electrode 320 may be inserted and secured in the indentation.

The second electrode 322 may be coupled to one side within the electrolyte bath 310 with a particular distance from the first electrode 320, and may generate hydrogen using the electrons and the electrolyte solution 312. The second electrode 322 can be secured by forming an indentation in substantially the same surface as that to which the first electrode 320 is secured, and then inserting one end of the second electrode 322 in the indentation.

As such, the first electrode 320 and second electrode 322 can be secured to the same surface, and be arranged in a vertical structure. The vertical structure here may include positioning the first electrode 320 and the second electrode 322 such that the surfaces of the first electrode 320 and the second electrode 322 are opposite to each other, as the arrangement having opposing surfaces may maximize the amount of hydrogen generation.

The second electrode 322 may be an inactive electrode. The second electrode 322 may receive the electrons that have traveled from the magnesium of the first electrode 320, to react with the electrolyte solution 312 and generate hydrogen.

As the second electrode 322 may be an inactive electrode and may not be expended, unlike the first electrode 320, the second electrode 322 can be formed to a lower thickness than that of the first electrode 320.

Looking at the chemical reactions involved at the second electrode 322, water may be dissociated at the second electrode 322 after receiving the electrons from the first electrode 320, whereby hydrogen may be generated.

The reaction above can be represented by the following Reaction Scheme 2.

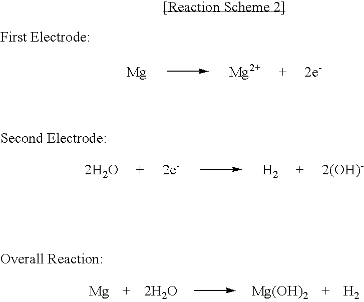

The rate and efficiency of the chemical reactions described above are determined by a number of factors. Examples of factors that determine the reaction rate include the area of the first electrode 320 and/or the second electrode 322, the concentration of the electrolyte solution 312, the type of the electrolyte solution 312, the number of first electrodes 320 and/or second electrodes 322, the method of connection between the first electrode 320 and the second electrode 322, and the electrical resistance between the first electrode 320 and the second electrode 322, etc.

Changes in the factors described above can alter the amount of electric current (i.e. the amount of electrons) flowing between the first electrode 320 and second electrode 322, whereby the rate of the electrochemical reaction represented in Reaction Scheme 2 may be changed. A change in the rate of the electrochemical reaction will result in a change in the amount of hydrogen generated at the second electrode 322.

Thus, in embodiments of the invention, it is possible to adjust the amount of hydrogen generated by adjusting the amount of electric current flowing between the first electrode 320 and the second electrode 322. The underlying principle of this can be explained by the following Equation 1 using Faraday's law.

$${N}_{hydrogen} = \frac{i}{nE} \\ {N}_{hydrogen} = \frac{i}{2 \times 96485} ( mol ) \\ \begin{matrix}{V}_{hydrogen} = \frac{i}{2 \times 96485} \times 60 \times 22400 ( ml \text{/} min ) \\ = 7 \times i ( ml \text{/} min )\end{matrix} \qquad [ Equation 1 ]$$

Here, N_{hydrogen} represents the amount of hydrogen generated per second (mol/sec), and V_{hydrogen} represents the volume of hydrogen generated per minute (ml/min). i represents current (C/s), n represents the number of reacting electrons (mol), and E represents the charge per one mole of electrons (C/mol).

With reference to Reaction Scheme 2 described above, as two electrons react at the second electrode 322, n equals 2, and the charge per one mole of electrons is about −96,485 coulombs.

The volume of hydrogen generated in one minute can be calculated by multiplying the amount of hydrogen generated in one second by the time (60 seconds) and the volume of one mole of hydrogen (22,400 ml).

If the fuel cell is used in a 2 W system, the required amount of hydrogen may be about 42 ml/mol, and 6 A of electric current may be needed. If the fuel cell is used in a 5 W system, the required amount of hydrogen may be about 105 ml/mol, and 15 A of electric current may be needed.

In this way, by adjusting the amount of electric current flowing between the first electrode 320 and the second electrode 322, the hydrogen generating apparatus 300 can be made to generate the amount of hydrogen required by the connected fuel cell.

Among the factors listed above that determine the reaction rate for generating hydrogen at the second electrode 322 of the hydrogen generating apparatus 300, those factors other than the electrical resistances between the first electrode 320 and the second electrode 322 are determined when constructing the hydrogen generating apparatus 300, and thus are not easy to change.

Thus, in this particular embodiment of the invention, the hydrogen generating apparatus 300 may include a control unit (not shown) between the first electrode 320 and the second electrode 322, to adjust the electrical resistance of the first electrode 320 and second electrode 322, and thereby control the amount of electrons flowing from the first electrode 320 to the second electrode 322.

In other words, by changing the electrical resistance between the first electrode 320 and the second electrode 322 based on the above Equation 1, the magnitude of the electric current between the first electrode 320 and the second electrode 322 can be adjusted, making it possible to generate hydrogen by an amount required by the fuel cell.

In certain embodiments of the invention, the first electrode 320 can be made of a metal other than magnesium that has a relatively high ionization tendency, such as iron (Fe) or an alkali metal such as aluminum (Al), zinc (Zn), etc. The second electrode 322 can be made of a metal such as platinum (Pt), copper (Cu), gold (Au), silver (Ag), iron (Fe), etc., that has a relatively lower ionization tendency than that of the metal used for the first electrode 320.

The control unit may adjust the rate by which the electrons generated at the first electrode 320 by the electrochemical reactions are transferred to the second electrode 322. That is, the control unit may adjust the electric current.

The control unit may be inputted with the amount of power or amount of hydrogen required by the fuel cell, and if the required value is high, may increase the amount of electrons flowing from the first electrode 320 to the second electrode 322, or if the required value is low, may decrease the amount of electrons flowing from the first electrode 320 to the second electrode 322.

For example, the control unit may include a variable resistance element, to adjust the electric current flowing between the first electrode 320 and second electrode 322 by varying the resistance value, or may include an on/off switch, to adjust the electric current flowing between the first electrode 320 and second electrode 322 by controlling the on/off timing.

Here, a conductive coating layer 350 may be formed, which may be interposed between one end of the first electrode 320 and an inner wall of the electrolyte bath 310 formed by an indentation. Also, a conductive coating layer 351 may be formed between one end of the second electrode 320 and an inner wall of the electrolyte bath 310 formed by an indentation.

The conductive coating layers 350, 351 may be coupled to the control unit through a wire. The wire may be formed by wire bonding.

The conductive coating layers 350, 351 can be made from a metallic material that allows the conduction of electricity, an example of which includes gold. The conductive coating layers 350, 351 may be formed by at least one of an inkjet coating method, a spray coating method, a sputtering method, and a thin film deposition method. This particular embodiment provides an example in which the conductive coating layers 350, 351 may be coated onto one side of the first electrode 320 and the second electrode 322, respectively, in the form of a thin film by an inkjet coating method, and may be connected with wires.

By coating a conductive material onto one side of the first electrode 320 and the second electrode 322, the electrons generated at the first electrode 320 may readily be moved through a wire to the control unit, and may readily be moved through a wire to the second electrode 322.

Thus, by using the conductive coating layers 350, 351 to connect the electrodes 320, 322 to an external circuit, the resistance between the circuit and the electrodes 320, 322 can be reduced, whereby the movement of electrons generated at the magnesium electrodes to the stainless steel electrodes can be facilitated.

The smaller the gaps between electrodes, and the greater the number of electrodes employed, the greater may be the amount of hydrogen generated by the electrochemical reactions.

As such, in order to increase the number of electrodes, an additional first electrode 330 and second electrode 332 can be formed on substantially the same surface as that on which the second electrode 322 is formed.

The types and operating effects of the first electrode 330 and second electrode 332 are as described above, where the first electrode 330 generates electrons, and the second electrode 332 generates hydrogen using the generated electrons and the electrolyte solution 312.

As described above, by forming the electrodes continuously, the amount of hydrogen generation can be increased further, and the electrodes can be formed repeatedly for a multiple number of times.

The magnesium electrodes and the stainless steel electrodes can be stacked repeatedly in alternation to increase the rate of hydrogen generation, and the electrodes can be implemented in the form of thin films. In this way, the number of electrodes can be increased, and the gaps between electrodes can be decreased, making it possible to provide the hydrogen generating apparatus 300 in a compact size.

To increase the number of electrodes even further, a first electrode 340 may be included, which may be coupled to the other side within the electrolyte bath 310 to generate electrons, as well as a second electrode 342, which may be coupled to the other side in the electrolyte bath 310 with a particular distance from the first electrode 340, and which may generate hydrogen using the electrons and the electrolyte solution 312. Here, it is apparent that the first electrode 340 and second electrode 342 can be of a substantially same type as those of the first electrode 320 and second electrode 322 coupled to the one side of the electrolyte bath 310, and that the first electrode 340 and second electrode 342 can have substantially the same coupling relationship and substantially the same effects as those of the first electrode 320 and second electrode 322.

Thus, the first electrode 340 and the second electrode 342 may each have one end inserted and secured in an indentation. Also, a control unit can be used to control the amount of electrons for the first electrode 340 and second electrode 342.

In addition, conductive coating layers 354, 355 may further be included between one end of each of the first and second electrodes 340, 342 and the inner wall of the electrolyte bath 310 formed by the indentation. As described above, the resistance between the electrode and the circuit can be reduced by way of the conductive coating layers 354, 355, to facilitate the movement of the electrons.

Of course, multiple electrodes can be formed on the other side on the inner wall of the electrolyte bath 310.

The amount of electrical power or amount of hydrogen required by a fuel cell can be inputted to the hydrogen generating apparatus 300. For this, the hydrogen generating apparatus 300 may be joined to the fuel cell to receive the input directly from the fuel cell, or the hydrogen generating apparatus 300 may be equipped with a separate input device to receive input from the user on the amount of electrical power or amount of hydrogen required. The hydrogen generating apparatus 300 may control the flow of electrons in accordance with the amount of hydrogen or amount of electrical power required by the fuel cell.

In embodiments of the invention, there may be one first electrode 320 and/or one second electrode 322, or there may be two or more first and second electrodes 320, 322. If the numbers of first electrodes 320 and/or second electrodes 322 are increased, the amount of hydrogen generation may be increased for the same duration of time, making it possible to generate a desired amount of hydrogen in a shorter time period.

The hydrogen generated by multiple electrodes of a thin film structure as described above can be made to pass through a gas-liquid separation membrane positioned between the electrolyte bath 310 and the hydrogen outlet 360 through which the hydrogen is discharged. The gas-liquid separation membrane may permit the discharge of hydrogen while preventing the discharge of the electrolyte solution 312.

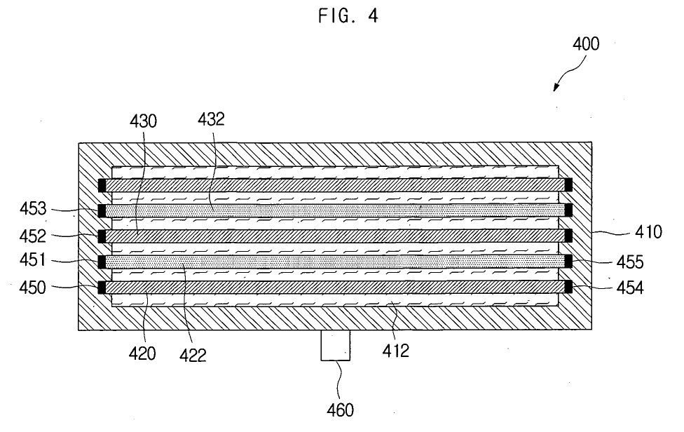

FIG. 4 is a cross-sectional view schematically illustrating a hydrogen generating apparatus according to another embodiment of the invention.

The hydrogen generating apparatus 400 may include an electrolyte bath 410, an electrolyte solution 412, first electrodes 420, 430, second electrodes 422, 432, conductive coating layers 450, 451, 452, 453, 454, 455, and a hydrogen outlet 460.

The components referred to by the same names as those described for the embodiment depicted in FIG. 3 may have substantially the same operating effect. As such, the following descriptions will focus more on the differences from the previously described embodiment. One end and the other end of the first electrode 420 may be inserted and coupled to indentations formed in the one side and the other side within the electrolyte bath 410, and one end and the other end of the second electrode 422 may be inserted and coupled to indentations formed in the one side and the other side within the electrolyte bath 410.

Of course, conductive coating layers 450, 451, 452, 453, 454, 455 may be applied between the inner walls of the indentations and the electrodes. In this way, the contact areas of the first electrodes 420 and second electrodes 422 can be maximized, for an increased amount of hydrogen generation.

It is to be appreciated that aspects of the invention also provide a fuel cell power generation system that includes the fuel cell which is supplied with the hydrogen generated in the hydrogen generating apparatus described above, and which converts the chemical energy of the hydrogen to electrical energy to produce a direct electrical current.

When the hydrogen generating apparatus provided in this embodiment is applied to a fuel cell, the apparatus for generating hydrogen can be implemented in a minute size, making it possible to provide a compact fuel cell. Furthermore, the gaps between electrodes may be reduced, and the number of electrodes may be increased, to enable a high efficiency in utilizing the electrodes.

As set forth above, a hydrogen generating apparatus according to certain embodiments of the invention can be structured to have electrodes and conductive coating layers secured to the inside of the electrolyte bath, to reduce resistance between the electrodes and an external circuit and facilitate the movement of electrons.

Also, the gaps between electrodes may be reduced, and the number of electrodes may be increased, to provide a higher efficiency and a smaller volume.

Also, hydrogen may be generated using environment-friendly materials, instead of using separate BOP units, which consume electrical power and which are difficult to provide in small sizes.

In addition, pure hydrogen can be generated at room temperature using electrochemical reactions, and the system can be implemented in a simple structure, while costs can be reduced.

Furthermore, in contrast to conventional apparatus, in which the hydrogen is generated to a certain fixed amount, certain embodiments of the invention make it possible to adjust the amount of hydrogen generation according to the requirements of the user or the fuel cell, by adjusting the electric current between electrodes. As such, the fuel cell can be employed in products such as mobile equipment, etc., in which the amount of power consumption changes frequently.

While the spirit of the invention has been described in detail with reference to particular embodiments, the embodiments are for illustrative purposes only and do not limit the invention. It is to be appreciated that those skilled in the art can change or modify the embodiments without departing from the scope and spirit of the invention.

What is claimed is:

1. A hydrogen generating apparatus comprising:
an electrolyte bath containing an electrolyte solution;
a first electrode coupled to one side within the electrolyte bath and configured to generate electrons; and
a second electrode coupled to the one side within the electrolyte bath with a predetermined distance from the first electrode, the second electrode configured to generate hydrogen using the electrons and the electrolyte solution.

2. The hydrogen generating apparatus of claim 1, wherein a first indentation is formed on the one side within the electrolyte bath,
and the first electrode has one end thereof inserted and secured in the first indentation.

3. The hydrogen generating apparatus of claim 1, further comprising:
a control unit configured to control an amount of electrons flowing from the first electrode to the second electrode.

4. The hydrogen generating apparatus of claim 2, further comprising:
a first conductive coating layer interposed between the one end of the first electrode and an inner wall of the electrolyte bath formed by the first indentation.

5. The hydrogen generating apparatus of claim 4, wherein the first conductive coating layer is formed from gold.

6. The hydrogen generating apparatus of claim 4, wherein the first conductive coating layer is formed by at least one of an inkjet coating method, a spray coating method, a sputtering method, and a thin film deposition method.

7. The hydrogen generating apparatus of claim 1, wherein the first electrode and the second electrode are arranged in a vertical structure.

8. The hydrogen generating apparatus of claim 1, further comprising:
a third electrode coupled to the one side within the electrolyte bath and configured to generate electrons; and
a fourth electrode coupled to the one side within the electrolyte bath with a predetermined distance from the third electrode, the fourth electrode configured to generate hydrogen using the electrons and the electrolyte solution.

9. The hydrogen generating apparatus of claim 3, further comprising:
a fifth electrode coupled to the other side within the electrolyte bath and configured to generate electrons; and
a sixth electrode coupled to the other side within the electrolyte bath with a predetermined distance from the fifth electrode, the sixth electrode configured to generate hydrogen using the electrons and the electrolyte solution.

10. The hydrogen generating apparatus of claim 9, wherein a second indentation is formed in the other side within the electrolyte bath,
and the fifth electrode has one end thereof inserted and secured in the second indentation.

11. The hydrogen generating apparatus of claim 9, further comprising:
a control unit configured to control an amount of electrons flowing from the fifth electrode to the sixth electrode.

12. The hydrogen generating apparatus of claim 10, further comprising:
a second conductive coating layer interposed between the one end of the fifth electrode and an inner wall of the electrolyte bath formed by the second indentation.

13. The hydrogen generating apparatus of claim 12, wherein the second conductive coating layer is formed from gold.

14. The hydrogen generating apparatus of claim 9, wherein the fifth electrode and the sixth electrode are arranged in a vertical structure.

15. The hydrogen generating apparatus of claim 9, wherein the first electrode and the fifth electrode are formed as an integrated body.

16. The hydrogen generating apparatus of claim 1, wherein the electrolyte bath further comprises:
a hydrogen outlet configured to discharge the hydrogen.

17. A fuel cell power generation system comprising:
a hydrogen generating apparatus, the hydrogen generating apparatus comprising:
an electrolyte bath containing an electrolyte solution,
a first electrode coupled to one side within the electrolyte bath and configured to generate electrons, and
a second electrode coupled to the one side within the electrolyte bath with a predetermined distance from the first electrode, the second electrode configured to generate hydrogen using the electrons and the electrolyte solution; and
a fuel cell configured to produce a direct electrical current by receiving the hydrogen generated by the hydrogen generating apparatus and converting chemical energy of the hydrogen into electrical energy.

18. The fuel cell power generation system of claim 17, wherein a first indentation is formed on the one side within the electrolyte bath,
and the first electrode has one end thereof inserted and secured in the first indentation.

19. The fuel cell power generation system of claim 17, further comprising:
a control unit configured to control an amount of electrons flowing from the first electrode to the second electrode.

20. The fuel cell power generation system of claim 18, further comprising:
a first conductive coating layer interposed between the one end of the first electrode and an inner wall of the electrolyte bath formed by the first indentation.

21. The fuel cell power generation system of claim 20, wherein the first conductive coating layer is formed from gold.

22. The fuel cell power generation system of claim 20, wherein the first conductive coating layer is formed by at least one of an inkjet coating method, a spray coating method, a sputtering method, and a thin film deposition method.

23. The fuel cell power generation system of claim 17, wherein the first electrode and the second electrode are arranged in a vertical structure.

24. The fuel cell power generation system of claim 17, further comprising:
a third electrode coupled to the one side within the electrolyte bath and configured to generate electrons; and
a fourth electrode coupled to the one side within the electrolyte bath with a predetermined distance from the third electrode, the fourth electrode configured to generate hydrogen using the electrons and the electrolyte solution.

25. The fuel cell power generation system of claim 19, further comprising:
a fifth electrode coupled to the other side within the electrolyte bath and configured to generate electrons; and
a sixth electrode coupled to the other side within the electrolyte bath with a predetermined distance from the fifth electrode, the sixth electrode configured to generate hydrogen using the electrons and the electrolyte solution.

26. The fuel cell power generation system of claim 25, wherein a second indentation is formed in the other side within the electrolyte bath,
and the fifth electrode has one end thereof inserted and secured in the second indentation.

27. The fuel cell power generation system of claim 25, further comprising:
a control unit configured to control an amount of electrons flowing from the fifth electrode to the sixth electrode.

28. The fuel cell power generation system of claim 26, further comprising:
a second conductive coating layer interposed between the one end of the fifth electrode and an inner wall of the electrolyte bath formed by the second indentation.

29. The fuel cell power generation system of claim 28, wherein the second conductive coating layer is formed from gold.

30. The fuel cell power generation system of claim 25, wherein the fifth electrode and the sixth electrode are arranged in a vertical structure.

31. The fuel cell power generation system of claim 25, wherein the first electrode and the fifth electrode are formed as an integrated body.

32. The fuel cell power generation system of claim 17, wherein the electrolyte bath further comprises:
a hydrogen outlet configured to discharge the hydrogen.
